(19) United States
(12) Patent Application Publication
(10) Pub. No.: US 2020/0219182 A1
(43) Pub. Date: Jul. 9, 2020

(54) System and Method for Life Planning

(71) Applicant: Lawrence J. Frederick, Calgary (CA)

(72) Inventor: Lawrence J. Frederick, Calgary (CA)

(21) Appl. No.: 16/238,715

(22) Filed: Jan. 3, 2019

(51) Int. Cl. G06Q 40/02; G06F 16/23

(52) U.S. Cl. CPC G06Q 40/02; G06F 16/2379

(57) ABSTRACT

The aspects herein describe a life planning system and method for multiple careers. The life planning system has a computer communicating with one or more servers using a transmitter. The computer executes instructions from a computer-readable medium and include: retrieving a workbook form from the server(s); displaying the workbook form and accepting life planning data; transmitting the life planning data to the server(s); and transmitting a permission to the server(s) in order to permit access to the life planning data by another computing device. The method of life planning comprises: retrieving a workbook form from the server(s); displaying the workbook form and accepting life planning data; determining a spending profile in retirement and a net worth curve; and displaying the net worth curve. The net worth curve comprises a net worth axis and an age axis. The life planning data comprises user profile data and financial plan data.

### FIELD

This invention is in the field of life planning systems and methods, and more specifically to life planning systems and methods for multiple careers.

### BACKGROUND

U.S. Pub. No. 2012/0022949 to George, herein explicitly incorporated by reference in its entirety, discloses a method for formulating a life plan. A user estimates how many years he or she has left before they believe they will become inactive. The user identifies desirable activities and goals. The user prioritizes desirable activities and consolidated goals in one-on-one comparisons. The computer ranks the consolidated goals highest to lowest based on the results of the one-on-one comparisons. The computer sets up a timeline to achieve the consolidated goals using the prioritized list and the estimated time left. The computer system places the results in a project management and reminder system to assist the user in achieving his consolidated goals. The computer queries a life plan networking database to find other users whose timelines match the current users and presenting these matches for networking.

U.S. Pub. No. 2005/0096973 to Heyse et al., herein explicitly incorporated by reference in its entirety, discloses an integrated life and career management systems and methods for providing comprehensive life and career management services to individuals over a network. The integrated life and career management systems and methods allow individuals to dynamically and continuously record, witness, monitor, and manage their life and career development. Professional advisors may access and reference information about individuals to render assistance to the individual. In one implementation, a dynamic personal growth and development profile is automatically constructed and recorded based on tests, instruments, and exercises taken by the individual. The profile provides a psychometric self-portrait of the individual among other information. A comprehensive and flexible life and career plan corresponding to the profile is generated, so as to provide guidance to the individual when life and career decisions are made.

U.S. Pub. No. 2014/0089219 to Mathews, herein explicitly incorporated by reference in its entirety, discloses methods and systems that provide personal, educational, and career analytics for students to navigate the ever increasing educational and career landscape. Instant simulated journeys of success may be created by translating personal, educational, and career data into visual and navigational choices for every student and parent. Users may be allowed instant access to all K1-to-K20 personalized education records in order to continually analyze that data against the labor market, labor data, personal interests, and educational choices and job forecasts in order to produce continual options and validation. Results may be produced that help students and parents more accurately prepare and plan by visually seeing progress, strengths, weaknesses, funding needs, options and statistics on a regular basis.

U.S. Pub. No. 2015/0100638 to Cofield, herein explicitly incorporated by reference in its entirety, discloses a cloud-based, personal productivity and life enhancement tool comprising a central server connected to the internet for containing at least one personal productivity and life enhancement modules. The central server is connected to a searchable information database store for privately keeping user information generated from the at least one personal productivity and life enhancement modules, and at least one user interface for accessing the personal productivity and life enhancement modules and searchable information database store. The preferred personal productivity and life enhancement modules comprise a daily life log module, an illumination module, a vision module, an achievement module, and a revelation module.

U.S. Pub. No. 2016/0335724 to Mak, herein explicitly incorporated by reference in its entirety, discloses a life-components oriented financial planning system. A timeline planning interface module generates an interface having a plurality of histograms representing a planning target's “life components”. A projection generation module comprises projection generation formulae, wherein the entire projection data form the projection set of a “life road”. A financial destiny chart module creates financial destiny charts from projection data in projection sets. Each life component comprises four kinds of “projections”, income, expenses, assets and liabilities. The position and length of the histogram represent values of a corresponding life component. The planning target's life road comprises life components. The life components are grouped by financial modules and formed from projections.

### SUMMARY

Any and/or all aspects as described herein in any and/or all combinations.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a schematic view of a life planning system;

FIG. 2 is a block diagram of a computing device for the life planning system;

FIG. 3 is a block diagram of a server device for the life planning system;

FIG. 4 is a resource curve for the life planning system;

FIG. 5 is the resource curve for the life planning system divided into paid time and unpaid time;

FIG. 6 is the resource curve for the life planning system demonstrating a plurality of paid activities and educational activities;

FIG. 7 is the resource curve for the life planning system demonstrating a plurality of leisure activities; and

FIG. 8 is a chart of a length of time scheduled for each activity.

### DETAILED DESCRIPTION

Although prior life planning systems and methods (e.g. tools) exist, such tools may be insufficient in that these tools have not considered an individual or user may experience many different careers during their lifetime. The life planning system 100 and method as described herein may allow for exploration of a series of career changes to allow the individual or group of individuals to have a broader grasp of potential careers. The individual may value this system 100 and method since as types of careers and technologies continue to evolve the individual may be in a position to take advantage of different opportunities. For example in the current labor market in many countries, individuals rarely remain with one company throughout their career and individuals may frequently even change industries. Currently, individuals may typically consider only a next career move and may do so during volatile and stressful circumstances, such as during a layoff. This stressful and volatile situation may cause the individual to make a hasty decision that may not be in their best interests. If the individuals are able to plan for periodic career changes, the individuals may be better prepared for when one of these impromptu career moves is initiated. In another example, the individual may have a plan for several career changes made, and the individual may be in control of initiating career changes based on events or experiences through time.

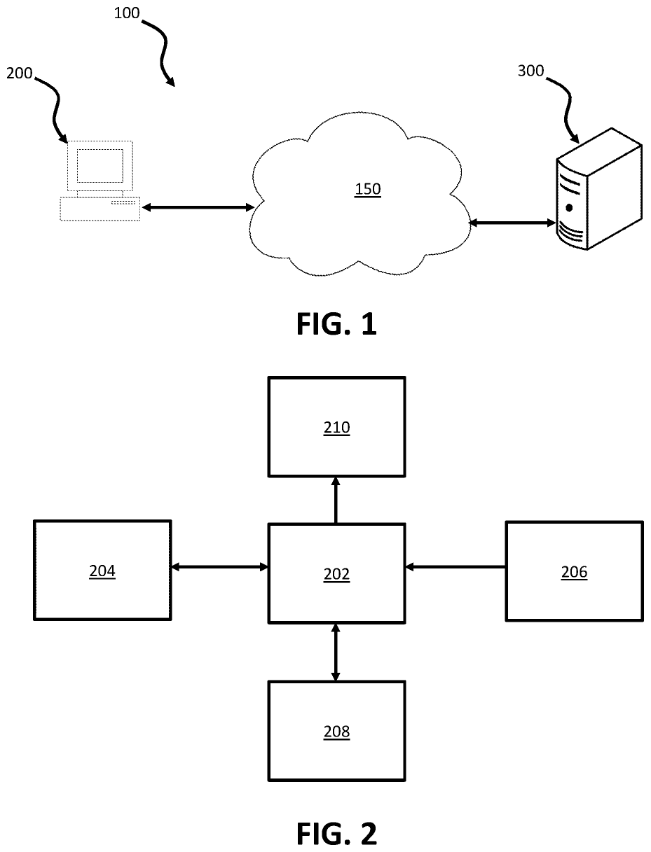

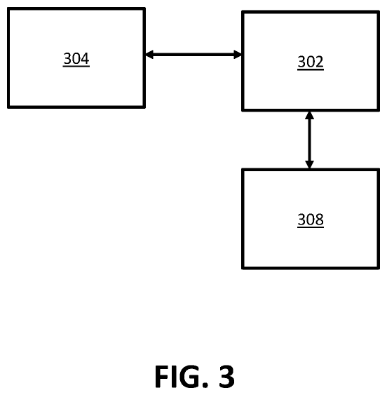

Turning to FIGS. 1 to 3, there is provided the life planning system 100 comprising at least one computing device 200 in communication with at least one server computing device 300 (e.g. server 300) over a network 150, such as the Internet. The at least one computing device 200 may be associated with a user of the life planning system 100. The computing device 200 may be a desktop computer, tablet, smart phone, etc. The at least one server 300 may be associated with a provider of the life planning system 100.

The computing device 200 may comprise a processor 202 executing instructions from or store data to a tangible, computer-readable medium 204 (e.g. memory, hard drive, etc.). The processor 202 may receive user input using an input interface 206, such as a mouse, keyboard, touch screen, etc. The processor 202 may communicate with the network 150 using a transceiver 208. The processor 202 may display a user interface on a display 210. Similarly, the server 300 may comprise a server processor 302 executing instructions from or store data to a tangible, computer-readable medium 304 (e.g. server memory, hard drive, etc.). The server processor 302 may communicate with the network 150 using a server transceiver 308. The processor 202, 302 may comprise a single or multicore processor, a field-programmable gate array (FPGA), an ASIC, etc. Although not explicitly described, it is understood that the computing device 200 and server 300 may comprise further electronic circuitry such as power circuitry, communication circuitry, user interface circuitry, etc. as required for operation.

The computing device 200 may retrieve a workbook form from the server 300 over the network 150. The workbook form may provide a plurality of fields on one or more forms for display on the display 210 in which the user may enter life planning data. The life planning data may then be transmitted from the computing device 200 to the server 300. The server 300 may store the life planning data for each user in a life planning database. The server 300 may analyze the life planning data for each user in order to identify potential careers, locations, training, mentors, and/or other information for consideration by the user. In some aspects, the user may provide permission to the life planning data associated with that user to another user, such as a spouse, life partner, parent, company, etc.

The workbook form may ask for user profile data, such as an age, a personality type, current values, a set of current skills, a set of desired career choices, hobbies, family plans, interests, life goals, a current employment, a location, an estimated life expectancy, and/or a retirement age. For example, the personality type may be determined using a Myers-Briggs personality type test. Alternatively, the server 300 may determine an estimated life expectancy based on the location and/or from a government website. In some aspects, the workbook form may ask the user for health-related data and/or permission to access health-related data from a health care provider and/or insurer in order to determine life expectancy and/or a paid work period. The health-related data may comprise inherited diseases, either through their family history or through DNA tests, such as offered by www.23andme.com. The workbook form may also ask the user to include financial plan data. The workbook form may be flexible to accommodate as much or as little input data as the user is able to provide.

The workbook form may allow for periodic updating of the user profile data as the user provides more information to the computing device 200 and/or server 300. For example, the results of additional personality tests, attributes, and/or skills may be added into the workbook form and the workbook form may be continually refined and modified to reflect these new parameters, providing additional plurality of options for consideration by the user. The workbook form may allow for portions to remain unresolved and/or offer choices based on career planning tools. These choices may be prioritized and placed in chronological order in the workbook form based on user input.

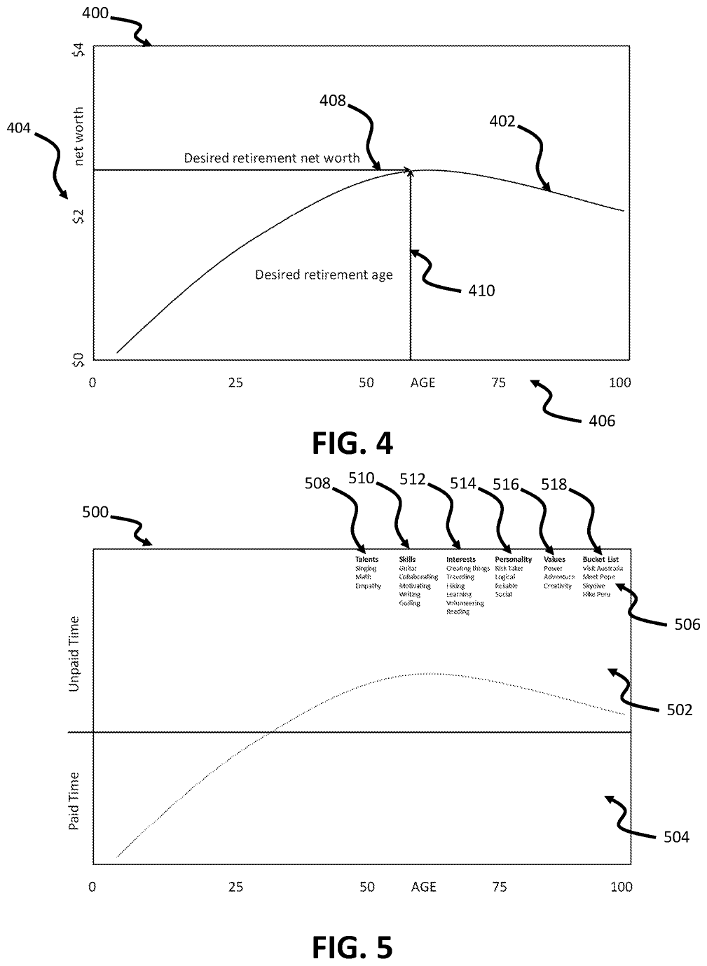

Once at least a portion of the user profile data has been entered and sent to the server 300, the server 300 may calculate a net worth curve 402 such as is shown in FIG. 4, as a net worth illustration 400, based on the user profile data and the financial plan data. The data required may include the user's current age and current net worth, a retirement age, a life expectancy, and a life style desired, which determines a spending profile in retirement. The net worth curve 402 may be plotted in the net worth illustration 400 with a net worth axis 404 and an age axis 406. The net worth curve 402 may determine a retirement net worth 408 at the user's desired retirement age 410. The server 300 may then transmit the net worth curve 402 to the computing device 200 for presentation on the display 210. The net worth curve 402 may represent a base for further refinement of the life plan. The net worth curve 402 may be a guide for the user to help narrow a range of potential career choices to meet this goal, or the net worth curve 402 may be adjusted to meet the career choices of the user. In this aspect, the net worth curve 402 is determined by the server 300, in another aspect, the net worth curve may be determined by the computing device 200.

Turning to FIG. 5, the net worth curve 402 is reduced in prominence and may be used as a background reference illustration for the life planning illustration 500. The life planning illustration 500 may be divided into unpaid time 502 and paid time 504. The paid time 504 may represent a number of hours spent creating a revenue stream that provides a foundation for the life plan that follows the net worth curve 402. The unpaid time 502 may represent a number of hours spent on leisure activities, relaxation, learning, hobbies, volunteering, family time, gathering resources, eating and/or sleeping. The portioning and prioritization of various activities in both paid and unpaid time may be adjustable by the user using a prioritization user interface.

A plurality of attributes 506 retrieved from the user profile data may be overlaid on a life planning illustration 500 in attribute categories. For example, the attribute categories may comprise talents 508, skills 510, interests 512, personality 514, values 516, and “bucket list” 518 (e.g. large life goals). In the example shown in FIG. 5, the talents comprise singing, math, empathy; the skills comprise guitar, collaborating, motivating, writing, and golfing; the interests comprise creating things, travelling, hiking, learning, volunteering, and reading; the personalities comprise risk taker, logical, reliable, and social; the values comprise power, adventure, and creativity; and the “bucket list” comprise visit Australia, meet Pope, skydive, and hike Peru. It may be desirable to include these lists on the life planning illustration 500 so the data may be readily available to the user to guide their decisions. The user may include items in the “Bucket List”, for example, in the workbook form at appropriate times to encourage the user to fulfill these desires.

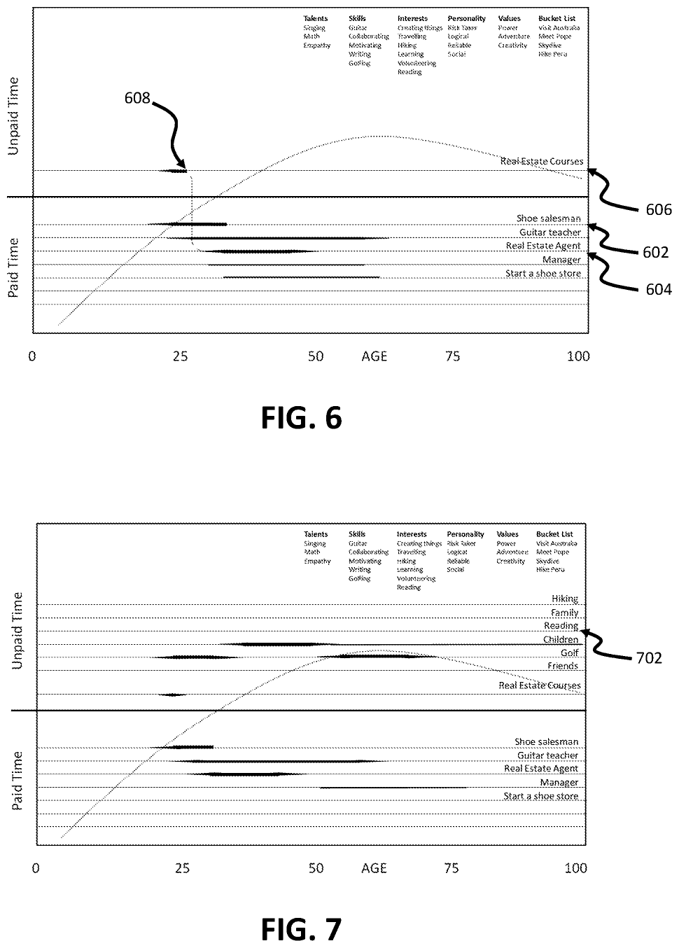

Turning to FIG. 6, which may be a more detailed version of the life planning illustration 500, the workbook form may guide the user through a process of discovering and highlighting possible career choices based, in part, on the user profile data. The possible career choices may be determined using the user's aptitude for various careers, hobbies, family time, and volunteering activities. The possible career choices may be suggested from at least one career requirement from industry and/or a pay for the possible career choices. The workbook form may prompt the user for a desired start time and a desired end time for each career. In another aspect, the server 300 may retrieve statistical data for the career, such as an average length that an employee may work in that current career and potential revenue, from a database in order to determine an estimated end of the current career. The user may be provided with a set of new careers to choose. Based on one or more educational requirements and/or other prerequisite requirements to enter another career, the computing device 200 may add educational hours before the desired start date to obtain all the prerequisites before entering the new career. The computing device 200 may retrieve the educational requirement and prerequisite requirements from the server 300 based on the location of the computing device 200 in order to select local educational institutions and/or licensing organizations or suggestions of mentors, educational institutions or companies that could assist the user in entering that career choice.

For the example shown in FIG. 6, the user may currently be a guitar teacher and a shoe salesman. The computing device 200 may create a line 602 for each of the two career activities. In this aspect, a thickness of the lines may reflect a number of hours per day spent on each activity. In another aspect, the thickness of the lines may reflect an amount of money earned per day for each activity. The user may provide the number of hours or the amount of money earned or alternatively, the computing device 200 may retrieve salary data from the server 300 in order to determine the amount of money earned. In some aspects, the salary data may be retrieved from sources such as, for example, Indeed.com, payscale.com, or other salary data sources. The salary data may be used to refine the financial plan of the user. The workbook form may also suggest warnings for a potential industry phase out based in part on a technological advance, a predicted economic condition, etc. For example, if the person is a truck driver, the server 300 may identify that the technological improvement of autonomous vehicles may decrease a number of truck driver positions available in developed countries. The server 300 may provide suggestions for training in other fields or suggest regions where there may be further need of truck drivers, such as in developing countries.

If the user plans to become a real estate agent 604, computing device 200 may ask for a start date when the user expects to start earning money as a real estate agent. The computing device 200 may also ask the user or retrieve data from the server 300 for the educational requirements and/or the other pre-career activities that are necessary for the user may start the career. These non-paid activities 606 may be added to the unpaid section 502 with an educational end 608 aligned with the start time of the real-estate career. The user may then adjust the start and end time in order to plan different scenarios.

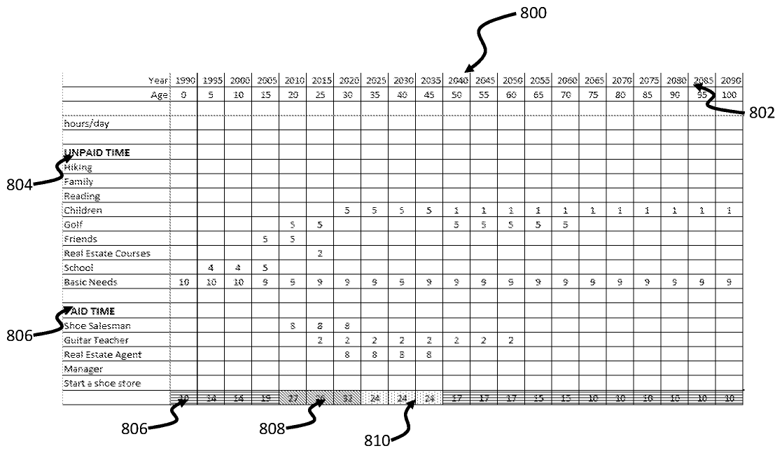

As shown in FIG. 7, which may be a further refinement of the life planning illustration 500, the user may enter unpaid activities 702. In this example, the unpaid activities 702 comprise hiking, family, reading, children, golf, friends, and real estate courses. Similar to the paid activities, the thickness of each line corresponds to an estimated time involved in those activities. In some aspects, the activities may include life activities such as time spent on eating, sleeping, gathering water or fuel, exercising or other basic needs for survival. This survival data may be retrieved from the server 300 in order to determine if the combination of activities for a particular time period exceeds a threshold.

For instances where the user may have less than 24-hours assigned for each day, the computing device 200 may prompt the user to enter additional activities and/or prompt the user to increase the time for one or more particular activities. For instances where the user may have more than 24-hours assigned for each day, the computing device 200 may prompt the user for a priority associated with each activity. The computing device 200 may then automatically adjust the time for each activity based at least in part on the priority associated with each activity. In some aspects, the computing device 200 may decrease the time spent on lower priority activity during the time period of a higher priority activity.

For example, the computing device 200 may determine which activities must be reduced in order to fit the activities into the user's life schedule. For example, the user may be a golfer, but must reduce the golfing activity (e.g. a lower priority activity) after the user has children in order to care for them (e.g. a higher priority activity). The golfing time may then increase after the children are grown and the higher priority activity has reduced in the required time. Finally, the golfing time may decrease as the user ages as expected with health deterioration.

Turning to FIG. 8, a life planning table 800 of the life planning illustration 500 presented in FIG. 7 is demonstrated. The life planning table 800 comprises a year and age 802 on an x-axis and the time spent per day on a y-axis. The life planning data may be entered in the life planning table 800 or graphically in the life planning illustration 500. Similar to the visualization of the life planning illustration 500 in FIG. 7, the time spent per day may be divided into unpaid time 804 and paid time 806. A total number of hours per day may be displayed at a bottom of the life planning table 800. When the total number of hours is less than 24-hours, a first visual indicator 806 (e.g. horizontal shading) may be shown indicating this state. When the total number of hours exceeds 24-hours, a second visual indicator 808 (e.g. diagonal shading) may be shown indicating this state. When the total number of hours equals 24-hours, a third visual indicator 810 (e.g. stipple shading) may be shown indicating this state. The user may manually adjust the number of hours in order to achieve equilibrium causing the total number of hours row to display the third visual indicator 810 for all of the cells. The life planning table 800 and the life planning illustration 500 may be interactive and linked so that changes in one may be automatically reflected in the other.

According to an aspect, the life planning system 100 may assist the user in planning for career changes and/or to develop suitable training and skills in advance of when a current employer terminates an employment relationship with the user. The life planning system 100 may reduce the stress and/or trauma associated with layoffs as suitable training and skills have already been acquired.

According to another aspect, the life planning system 100 may assist the user to be considering several career choices so that as dynamic economic conditions or other events occur, the user may be better positioned to make appropriate career choices, allowing the user to be in better control of their destiny.

According to another aspect, the life planning system 100 may assist the user in determining how finite time may be spent in order for the user to pursue both paid and unpaid time to realize one or more life goals.

In another aspect, the life planning system 100 may be used by students in order to plan their first career and future careers in order to select suitable courses, and to enable a more informed discussion about the future with their parents and teachers.

In yet another aspect, the life planning system 100 may assist the user in determining one or more activities that may be performed by others for hire. For example, the hours allocated to house cleaning may be performed by a cleaner at the expense of lowering the net worth curve 402 while freeing up time for paid or unpaid activities.

According to another aspect herein, the life planning system 100 may periodically prompt the user to make adjustments to the user profile data and/or the financial planning data.

According to an aspect, the life planning system 100 may consider one or more family members and may permit planning for the collective family. For example, the financial planning data may incorporate a change in the net worth curve 402 by having one spouse remain at home to raise children.

According to another aspect, the life planning system 100 may determine a suitable location in order to increase the income of the user. For example, if the user intends to become a musician, the life planning system 100 may determine locations where musicians earn a higher salary than other locations and/or may determine locations where musicians have a higher likelihood of becoming successful.

According to yet another aspect, the life planning system 100 may suggest connections for the user based on present and/or future careers. For example, if the career plan of the user includes becoming a paramedic, the life planning system 100 may suggest one or more local paramedics that have indicated they wish to mentor people who wish to become paramedics.

According to another aspect, the charts or graphs may be illustrated in alternative formats including diagrams of webs, roadways, waterways, and/or other visualizations.

In some aspects, the server 300 may provide the life planning data to one or more organizations, such as companies, schools, and/or governments.

Although the aspects described herein demonstrate the use of forms for retrieval of user profile data, other aspects may comprise questionnaires, illustrations, tables, etc.

The foregoing is considered as illustrative only of the principles of the invention.

Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A life planning system for a user comprising:
at least one computing device having a display;
a transceiver configured to communicate between the at least one computing device and at least one server computing device;
the at least one computing device comprising a processor executing a plurality of instructions from a tangible computer-readable medium, the instructions comprise:
retrieving a workbook form from the at least one server computing device;
displaying the workbook form on the display and accepting life planning data;
transmitting the life planning data via the transceiver to the at least one server computing device; and
transmitting a permission to the at least one server computing device in order to permit access to the life planning data by another computing device.

2. The life planning system according to claim 1, wherein the life planning data comprises a user profile data and a financial plan data.

3. The life planning system according to claim 2, wherein the user profile data comprises an age, a current net worth, a retirement age, a life expectancy, and a desired life style.

4. The life planning system according to claim 3, wherein the instructions further comprise: either determining a spending profile in retirement and a net worth curve or receiving the spending profile in retirement and the net worth curve via the transceiver from the at least one server device.

5. The life planning system according to claim 4, wherein the instructions further comprise: displaying the net worth curve on the display; the net worth curve comprising a net worth axis and an age axis, the age axis terminating at a life expectancy.

6. The life planning system according to claim 5, wherein the user profile data further comprises at least one of: a personality type, at least one value, at least one skill, at least one desired career choice, at least one hobby, a family plan, at least one interest, at least one life goal, a current employment, a current salary, and a location.

7. The life planning system according to claim 6, wherein the instructions further comprise: dividing a number of hours in a day into a paid time and an unpaid time based on the user profile data.

8. The life planning system according to claim 7, wherein the paid time is based on at least a portion of the financial plan data.

9. The life planning system according to claim 7, wherein the paid time represents a number of hours spent creating a revenue stream; and the unpaid time represents a number of hours spent on at least one of: leisure activities, relaxation, learning, hobbies, volunteering, family time, gathering resources, eating, and sleeping.

10. The life planning system according to claim 9, wherein the instructions further comprise: providing a prioritization user interface for portioning and prioritizing the paid time and the unpaid time by the user for each life year.

11. The life planning system according to claim 7, wherein the instructions further comprise: overlaying the paid time and the unpaid time on the net worth curve using the age axis.

12. The life planning system according to claim 6, wherein the instructions further comprise: determining a length of the current employment based on statistical data for a career type associated with the current employment in order to determine an estimated end time for the current employment.

13. The life planning system according to claim 12, wherein the instructions further comprise: prompting the user for the estimated end time for the current employment.

14. The life planning system according to claim 12, wherein the instructions further comprise: determining a set of possible career choices based on the user profile data; and receiving a new career selection from the set of possible career choices.

15. The life planning system according to claim 14, wherein the instructions further comprise: revising the net worth curve based on a salary of the new career selection.

16. The life planning system according to claim 14, wherein the set of possible career choices is determined based on the at least one skill, the at least one hobby, and the current employment.

17. The life planning system according to claim 14, wherein the instructions further comprise: determining at least one pre-career activity for the new career selection.

18. The life planning system according to claim 17, wherein the instructions further comprise: adding at least one pre-career activity hour before the estimated end time for the current employment.

19. The life planning system according to claim 17, wherein the instructions further comprise: providing suggested local organizations based on the location and the at least one pre-career activity.

20. The life planning system according to claim 19, wherein the at least one pre-career activity comprise at least one of: at least one prerequisite requirement and at least one educational requirement.

21. The life planning system according to claim 11, wherein the instructions further comprise: providing a visual indicator during periods when the paid time and the unpaid time exceed 24-hours.

22. The life planning system according to claim 5, wherein the instructions further comprise: overlaying on the display at least a portion of the user profile data in at least one attribute category on the net worth curve.

23. The life planning system according to claim 11, wherein the at least one attribute category comprises at least one of talents, skills, interests, personality, values, and large life goals.

24. The life planning system according to claim 23, wherein the life planning data is incomplete.

25. The life planning system according to claim 24, the instructions further comprise: periodically updating the user profile data as additional data is provided to the at least one computing device.

26. The life planning system according to claim 14, the instructions further comprise:
providing a new location on the display based on the current employment or the new career selection.

27. A method of life planning for a user, the method executing on a computing device comprises:
retrieving a workbook form from at least one server computing device;
displaying the workbook form on a display and accepting life planning data, the life planning data comprises a user profile data and a financial plan data;
determining a spending profile in retirement and a net worth curve; and
displaying the net worth curve on the display; the net worth curve comprising a net worth axis and an age axis.

28. The method according to claim 27, wherein the user profile data comprises an age, a current net worth, a retirement age, a life expectancy, and a desired life style.

29. The method according to claim 27, wherein the user profile data further comprises at least one of: a personality type, at least one value, at least one skill, at least one desired career choice, at least one hobby, a family plan, at least one interest, at least one life goal, a current employment, a current salary, and a location.

30. The method according to claim 27 further comprises: dividing a number of hours in a day into a paid time and an unpaid time based on the user profile data.

31. The method according to claim 30, wherein the paid time is based on at least a portion of the financial plan data.

32. The method according to claim 30, wherein the paid time represents a number of hours spent creating a revenue stream; and the unpaid time represents a number of hours spent on at least one of: leisure activities, relaxation, learning, hobbies, volunteering, family time, gathering resources, eating, and sleeping.

33. The method according to claim 30 further comprises: providing a prioritization user interface for portioning and prioritizing the paid time and the unpaid time by the user for each life year.

34. The method according to claim 30 further comprises: overlaying the paid time and the unpaid time on the net worth curve using the age axis.

35. The method according to claim 29 further comprises: determining a length of the current employment based on statistical data for a career type associated with the current employment in order to determine an estimated end time for the current employment.

36. The method according to claim 35 further comprises: prompting the user for the estimated end time for the current employment.

37. The method according to claim 27 further comprises: determining a set of possible career choices based on the user profile data; and receiving a new career selection from the set of possible career choices.

38. The method according to claim 26, wherein the set of possible career choices is determined based on the at least one skill, the at least one hobby, and the current employment.

39. The method according to claim 37 further comprises: determining at least one pre-career activity for the new career selection.

40. The method according to claim 39 further comprises: adding at least one pre-career activity hour before the estimated end time for the current employment.

41. The method according to claim 39 further comprises: providing suggested local organizations based on the location and the at least one pre-career activity.

42. The method according to claim 39, wherein the at least one pre-career activity comprise at least one of: at least one prerequisite requirement and at least one educational requirement.

43. The method according to claim 30 further comprises: providing a visual indicator during periods when the paid time and the unpaid time exceed 24-hours.

44. The method according to claim 27 further comprises: overlaying on the display at least a portion of the user profile data in at least one attribute category on the net worth curve.

45. The method according to claim 44, wherein the at least one attribute category comprises at least one of talents, skills, interests, personality, values, and large life goals.

46. The method according to claim 27, wherein the life planning data is incomplete.

47. The method according to claim 46 further comprises: periodically updating the user profile data as additional data is provided to the at least one computing device.

48. The method according to claim 37 further comprises: providing a new location on the display based on the current employment or the new career selection.
